(19) United States
(12) Patent Application Publication
(10) Pub. No.: US 2009/0106046 A1
(43) Pub. Date: Apr. 23, 2009

(54) SYSTEM AND METHOD FOR UTILIZING INCENTIVES TO PROMOTE PATIENT EDUCATION AND COMPLIANCE

(76) Inventors: Charles A. Feldman, Buffalo Grove, IL (US); David Kliff, Buffalo Grove, IL (US)

Correspondence Address: LOEB & LOEB, LLP, 321 NORTH CLARK, SUITE 2300, CHICAGO, IL, 60610-4746, US

(21) Appl. No.: 12/253,738

(22) Filed: Oct. 17, 2008

Related U.S. Application Data
(60) Provisional application No. 60/981,350, filed on Oct. 19, 2007.

(51) Int. Cl. G06Q 50/00

(52) U.S. Cl. 705/2

(57) ABSTRACT

The invention generally relates to a system and method for utilizing incentives to promote patient education and compliance. More particularly, the present invention provides a user-accessible website in which various rewards are provide to a patient upon completion of various education and other health-related tasks in order to promote education, health-management, and compliance.

This application claims priority to U.S. Provisional Patent Application No. 60/981,350, filed, Oct. 19, 2007, which application is incorporated by reference herein in its entirety.

### TECHNICAL FIELD OF THE INVENTION

The invention generally relates to a system and method for utilizing incentives to promote patient education and compliance. More particularly, the present invention provides a user-accessible website in which various rewards are provide to a patient upon completion of various education and other health-related tasks in order to promote education, health-management, and compliance.

### BACKGROUND

Health care today is expensive and sometimes the costs associated with diseases is greater than the cost of the medical care itself. For example, according to the American Diabetes Association, employees with diabetes have more absences compared to employees without diabetes, resulting in lowered productivity. Use of a test for glycosylated hemoglobin as a measure of plasma glucose concentration over time can lower HbA1c level of a patient, resulting in better health and lowering the cost of medical care significantly. For example, a 1% reduction in HbA1c levels resulted in a savings of $685-$950 per year in mean total health care costs.

Conversely, poor compliance with prescribed medical care increases the total cost of health care significantly. For example, a study published in the Dec. 4, 2007, issue of the Annals of Internal Medicine noted that improper use of three medications (warfarin, insulin, and digoxin) caused almost 60,000 emergency room visits in one year for patients over 65. Health care professionals have realized that patient education is a key factor in the patient being able to properly manage their disease.

There is therefore a need for a program that will engage patients and provide incentives to patients suffering from a variety of diseases to become more educated about their health. While there are programs out there that provide rewards for obtaining specified health outcome results, none provides rewards for becoming educated about the disease, the patient's treatment options, and other health-related areas.

### BRIEF SUMMARY OF THE INVENTION

The present invention is a process for providing health care information and educational content to patients. The process includes providing a user-accessible website, the user-accessible website having at least one user-accessible module, the at least one user-accessible module being configured to provide a user the ability to access health-related educational content; determining the specific education content accessed and viewed by a user; awarding rewards incentives to the user based on the educational content accessed and viewed by the user; tracking the total amount of rewards incentives awarded to the user; and providing a selection of prizes that may be exchanged for a predetermined amount of rewards incentives.

### BRIEF DESCRIPTION OF THE FIGURES

FIG. 1 illustrates one exemplary embodiment of a system and method for implementing the present invention.

FIG. 2 depicts a screen shot of one example of a front page of a website in accordance with the present invention.

FIG. 3 depicts a screen shot of one example of a home page of a website in accordance with the present invention.

FIGS. 4-7 depict screen shots of one example of a health education module in accordance with the present invention.

FIGS. 8-11 depict screen shots of one example of a survey module in accordance with the present invention.

FIG. 12 depicts a screen shot of one example of a medical product education module in accordance with the present invention.

FIG. 13 depicts a screen shot of one example of health monitoring module in accordance with the present invention.

FIGS. 14-16 depict screen shots of one example of a pharmaceutical product education module in accordance with the present invention.

FIG. 17 depicts a screen shots of one example of a chat module in accordance with the present invention.

FIG. 18 depicts a screen shots of one example of referral module in accordance with the present invention.

FIG. 19 depicts a screen shot of one example of a target outcome module in accordance with the present invention.

Other systems, methods, features, and advantages of the present invention will be or will become apparent to one with skill in the art upon examination of the following figures and detailed description. All such additional systems, methods, features, and advantages are included within this description, are within the scope of the invention, and are protected by the accompanying claims. Accordingly, the present invention is not restricted except in light of the attached claims and their equivalents.

### DETAILED DESCRIPTION OF THE INVENTION

The present invention is a system and process for utilizing incentives to provide health-related educational content to individuals suffering from a disease or ailment (also referred to herein as a “patient”) in order to better educate the patients regarding health related issues while at the same time gathering information from a patient. To accomplish this goal, the present invention rewards patients for becoming better educated about their conditions. More particularly, the system provides a user-accessible web site that permits the individual to access various health-related content including educational presentations regarding diseases, disease management, treatment options, etc. The system also includes means for determining whether the individual has viewed a specific content, means for awarding reward incentives to the individual based on the content viewed by the user, means for tracking the reward incentives awarded to the individual, and means for permitting the individual to obtain prizes based on the earned reward incentives.

As will be discussed in more detail below, reward incentives may be earned by viewing the available educational contact, taking surveys, purchasing products, viewing information or demonstrations on the use of the products, monitoring the patient's health, participating in interactive chats, reviewing pharmaceutical product information, referring patients to the program, and achieving health targets and goals. The reward incentives can be provided as points, which can then be redeemed for rewards including, but not limited to, gift items, gift cards and entertainment awards.

By providing incentives as motivational tools for users to become educated about the their disease or condition, patients are more likely to learn, thus enabling them to better take command of their health and wellness. The ultimate goal is that patients will incorporate what they have learned into their daily regiment which ultimately increases the probability of better outcomes. This is particular importance as studies have shown that educated patients will utilize more of the available tools and therapies in order to better manage their disease.

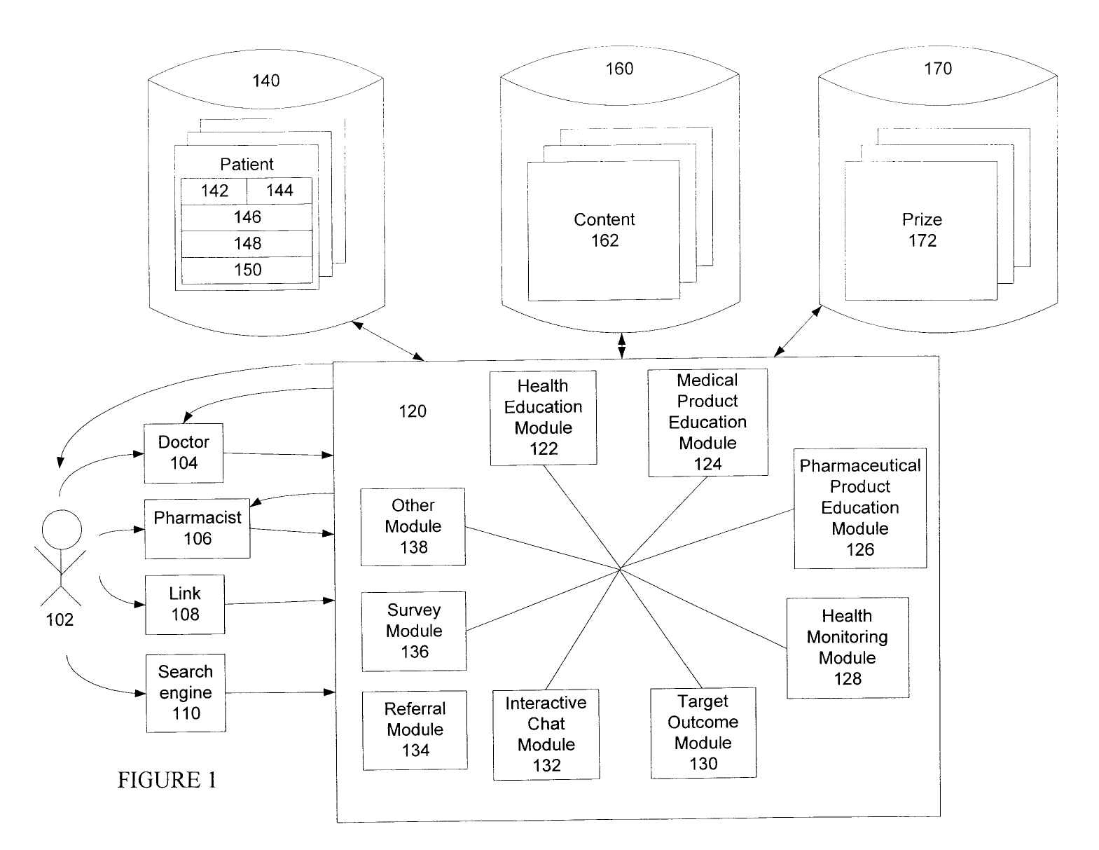

FIG. 1 illustrates one exemplary embodiment of the present invention. A patient 102 with a disease or ailment accesses a user-accessible web-site 120. The patient may be directed to the website 120 in any one of a number of ways. For example as shown in FIG. 1, the patient 102 may be directed to the website 120 by the patient's doctor 104, by a pharmacist 106, a link from another website 108, or a search engine 110. Of course, it is understood that these are examples and the patient 102 may be directed to the user-accessible website by any other method.

Once the patient 102 has accessed the user-accessible website 120, the patient 102 is requested to register by providing certain personal patient information, which is then stored in a database 140. The personal information may include for example, a user name 142 and password 144 for accessing the user-accessible website. The personal information may also include background information 146 regarding the patient's disease or ailment. The personal information may also include contact information 148, such as the patient's home address, phone number, as well as contact information for the patient's doctor or other medical care provider. After the patient has registered, a welcome e-mail may be generated and transmitted to the patient memorializing the patient's user name and password and providing information regarding the options available to the patient when accessing the user-accessible website.

Once the patient 120 has logged into the website 120, the patient 102 is provided with access to a plurality of modules 122-136, each of which is coupled to a database 160 having health-based content 162. In one embodiment, the content made available to the patient within each of these modules may be filtered and tailored based on the information provided by the patient 102. For example, if the patient indicates that he or she has diabetes, then each of the modules may be configured to provide health-based content related to diabetes.

Additionally, the patient's accessing and viewing history for the various modules is tracked and the user is awarded points based on the history. The method by which a patient can earn points in each module will be describe in additional detail below. Once earned, information identifying the number of earned points 150 is logged for the patient in the patient information database 140. These points may then be traded in by the patient for an available set of prizes 172, which may include products, gifts, gift cards or the like. As shown in FIG. 1, the list of available prizes may be stored in database 170. Of course, it should be understood that while the personal information database 140, the health based content database 160, and the prize database 170, are shown as separate database, the information may also be stored in a single database or in more than three databases.

As shown in FIG. 1, the available modules may include an health educational modules 122, a medical product education module 124, a pharmaceutical product education module 126, a health monitoring modules 128, a target outcome module 130, an interactive chat module 132, a referral module 134, and a survey module 136. Of course, other modules 138 may also be provided.

In one embodiment, the health educational module 122 may be configured to provide a patent with access to various education presentations regarding a disease or ailment of the patient, as well as relevant nutrition, coping, and/or exercise information. The presentations may be provided using a variety of method including, but not limited to, written articles, audio, videos, and slide shows (e.g., using Microsoft Powerpoint or equivalent software). The patient may access presentations by searching for specific topics related to his or her disease or ailment. The health educational module 122 may also be configured to suggest most relevant or important presentations to the patient and to update the suggested presentations based on the presentations that has been previously viewed by the patient.

The health educational module 122 may also include means to determine whether a user has successfully viewed a specific presentation. As one example, these means may include providing one or more questions to the patient at the end of the presentation to ensure that the patient has viewed certain content. In one embodiment, the questions may be related to the content that was provided to the patient. However, the questions may also be directed to other topics, such as a patient' current treatment method, the patient's opinion on the website, or any other topic. Thus, it is understood that these questionnaires may be used not only to confirm that a patient has successfully viewed a certain presentation but to also provide a means for obtaining additional information and feedback from the patient.

As noted above, once it is determined that the patient has successfully viewed a certain presentation, the patient is awarded a requisite amount of points. The amount of points is a matter of design choice and may be altered based on the presentation being viewed. For example, more points may be awarded for a presentation that takes longer to view. The website may also be configured to award more points to topics that are deemed more critical, thus providing an additional incentive to the patient to view that more critical information.

The medical product education module 124 may be configured to provide educational content relating to health-based products that are relevant to the patient's disease or ailment. This content may include presentations relating to product information such as available product options, differences between the product options, explanation on properly using the products, and the like.

The pharmaceutical product education module 126 may be configured to provide to the patient informational content about available pharmaceutical products relating to the treatment of a particular disease or ailment. The available content may include information about the potential benefits of various pharmaceutical products, potential side effect and interactions, and the like.

As with the health education module, in the medical and pharmaceutical product information modules, the educational content may be provided in various presentation forms and the patient may be awarded points for viewing the available education presentation. Also as with the health education module, one or more questions may be provided at the conclusion of each presentation to ensure that the patient has viewed the content.

The health monitoring module 128 may be configured to permit the patient to record and monitor one or more aspects of the patient's health over time. For example, the health monitoring module 128 may be configured to permit a patient to monitor certain blood levels, hormone levels, or the like related to the patients' disease or ailment. The health monitoring module 128 may also be configured to permit a patient to monitor their weight and/or exercise regime. The health monitoring module 128 may also be configured to provide educational content regarding the types of things that the patient should be monitoring based on their disease or ailment, as well as the proper method for performing the tests.

Within the health monitoring module 128, points may be awarded to the patient based on various aspects. For example, the patient may be awarded points for regularly inputting information regarding the patient's health. The patient may also be awarded for viewing the relevant educational content regarding the information.

The target outcome module 130 may be configured to permit a patient to set various health-related goals. The goals may include, for example, obtaining certain test result levels, achieving a target weight, or regularly performing activities such as exercise or diet. The targets may be set by the patient or suggested by the website based on the patient's current condition. The patient may then be awarded points for reaching and/or maintaining their target.

The interactive chat module 132 may provides patients with the ability to ask specific questions relating to their disease or condition from health practitioners, or can be used to interact with other patients having the same or different condition. In this module, points may be awarded based on the number of chats initiated by the patient, or the amount of time that the patient spent chatting with another using the module.

The referral module 134 may permit the patient to refer other patients, friends or family to the user accessible website 120. The patient may be awarded points for each referral, or alternatively, for each individual that registers with the user-accessible website as a result of the referral.

Finally, the survey module 136 may be configured to provide a plurality of surveys to the patient. In one embodiment, the patient ay be permitted to select one or more of the plurality of surveys to take, or alternatively, the patient may be directed to a specific survey upon accessing the survey module 136. The surveys may designed to obtain personal information about the patient, obtain feedback about the website, obtain information regarding health-related products or stores for marketing purposes, or present questions relating to various educational information to test the knowledge of the patient and potentially determine the increase in health awareness of the patient based on use of the present invention. The questions can be in the form of multiple choice questions, yes/no questions or other types of questions. Upon completing a survey, the patient may be awarded a predetermined amount of points.

In one embodiment, status updates may be sent to the patient upon the occurrence of certain events. For example a communication may be sent to the patient upon registration, upon the patient earning reward points, or if new content relevant to the patient becomes available. Such communications may also be sent to the patient at predetermined times or at regular intervals. The communication may be by email, regular mail, text message, or using any other communication method.

In addition, the system described above may also be configured to transmit certain information to a health provider. For example, recorded test results may be transmitted to the patient's doctor 104 or pharmacist 106. The doctor or pharmacist may also be provided with information regarding the educational content viewed by the patient. In this way, the health provider can monitor the patient's health, as well the patient's level of education regarding their disease or ailment. By receiving this information, the health provider is better able to aid in managing the patient's health. The health provider may also suggest additional content that would be beneficial to the patient.

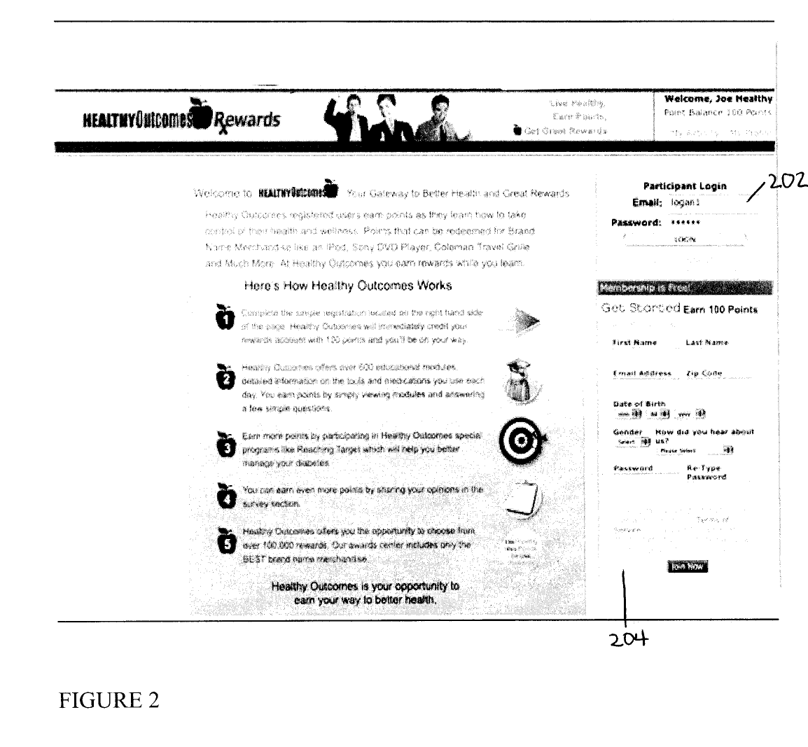

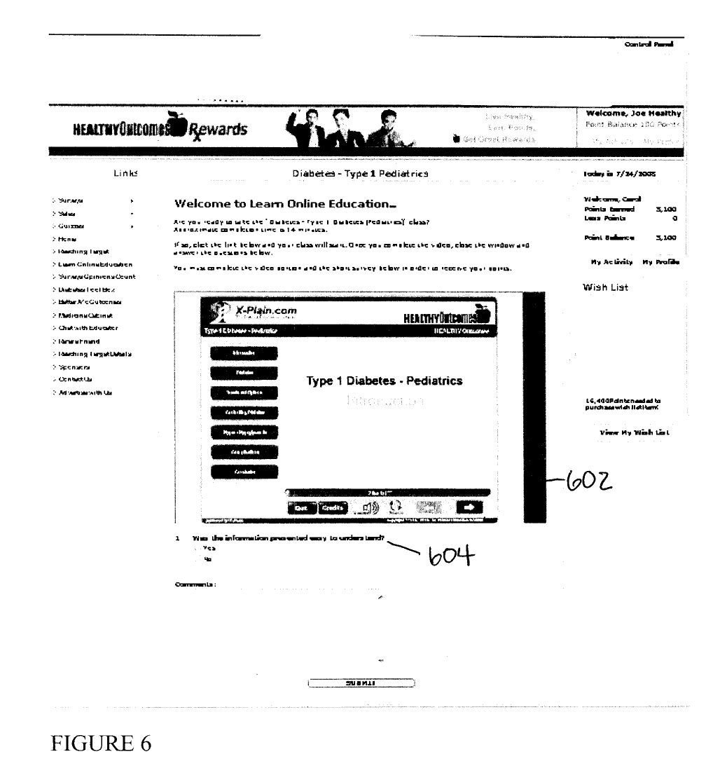

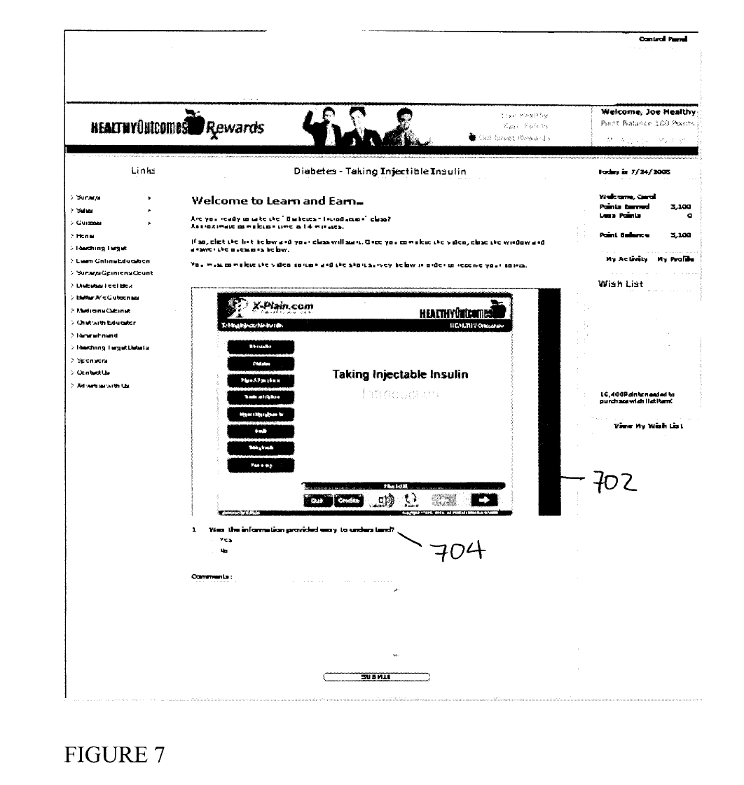

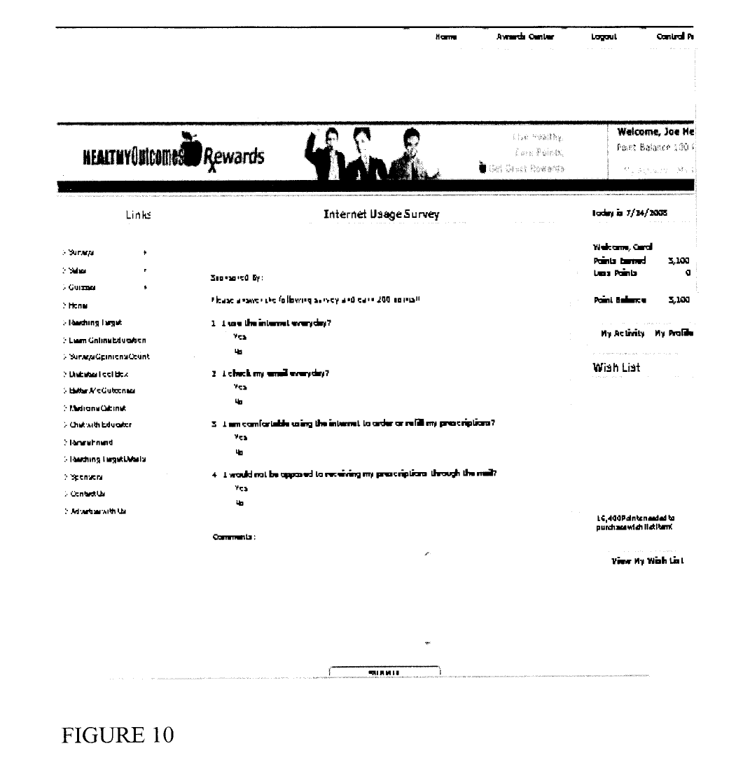

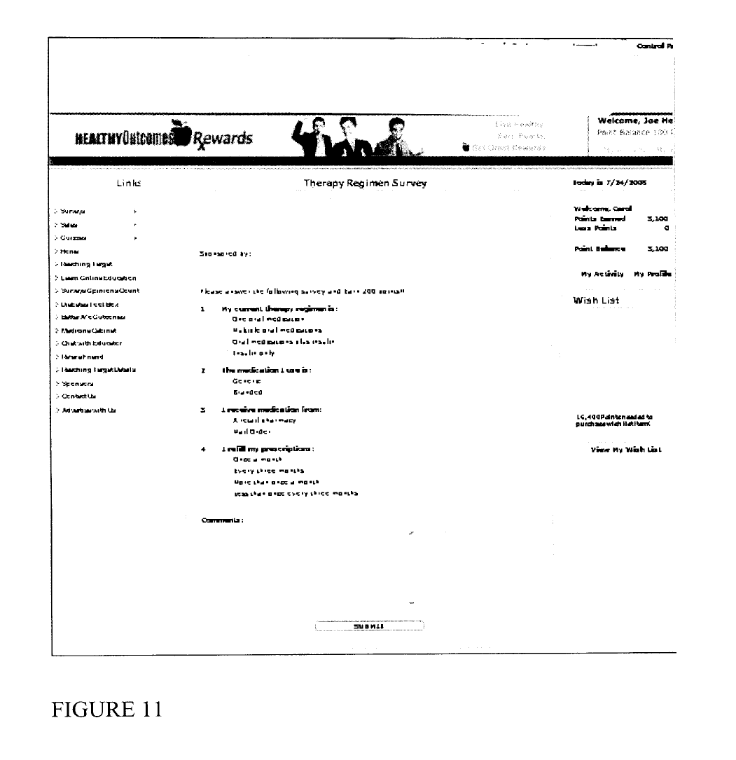

FIGS. 2-19 illustrate screen shots of one exemplary website in accordance with the present invention. In the following example, the illustrated website is directed to individual with diabetes, although it will be understood that the website may be directed to any disease or ailment, and may also be directed to multiple diseases or ailments.

FIG. 2 is a screen shot of one exemplary front page in accordance with the invention. As shown, this web page provides a login area 202 for a patient to log into his or her account, and a registration area 204 to permit a previously unregistered patient to register to with the website. In this embodiment, in order to register, the patient is asked to enter their name, email address, zip code, birth date, gender, identification of how they came to find the website, and an intended password. In this embodiment, the front page also provides an overview of the website in order to explain the available content and the method by which the user may obtain rewards while utilizing the website.

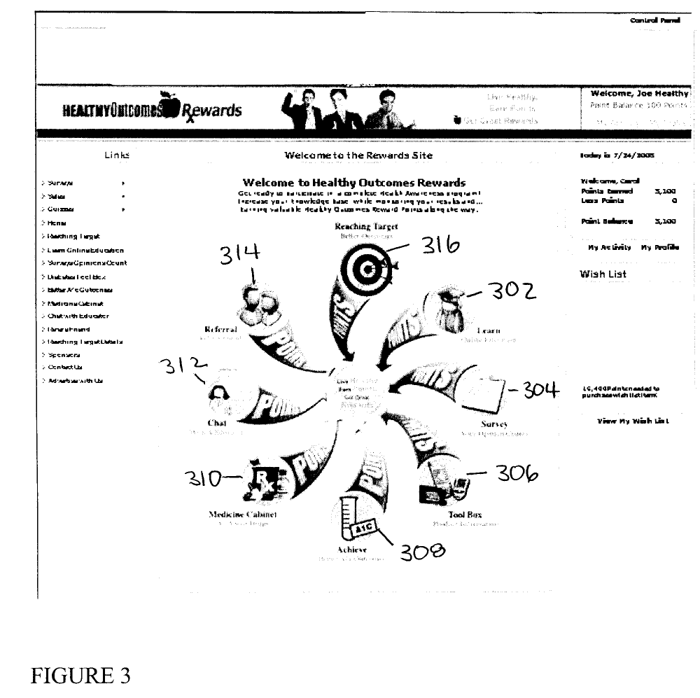

FIG. 3 illustrates one example of a home page accessible to the user upon logging into the website. Here, the patient is presented with a plurality of selectable modules. In this example, the modules are Learn 302 (i.e. health education module), Survey 304 (i.e., survey module), Tool Box 306 (i.e., medical product education module ), Achieve 308 (i.e., health monitoring module), Medicine Cabinet 310 (i.e., pharmaceutical product education module), Chat 312 (i.e., interactive chat module), Referral 314 (i.e., referral module), and Reaching Target 316 (i.e., target outcome module).

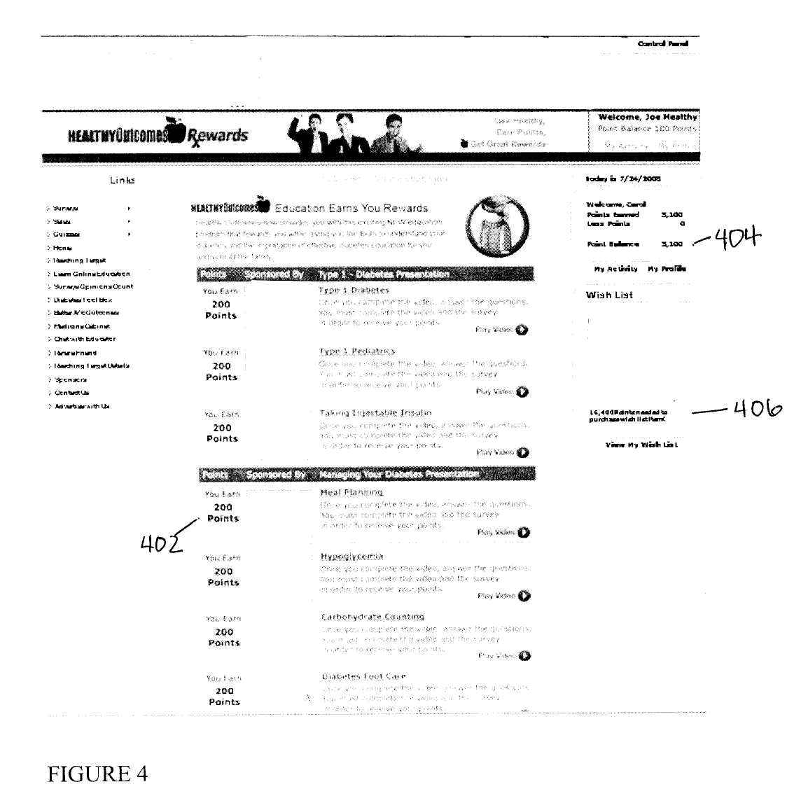

FIG. 4-7 illustrate various aspects of one example of a Learn module 302 having content relating to diabetes. In FIG. 4, upon selecting the Learn module in FIG. 3, the patient is presented with a plurality of selectable educational presentations 402. In this example, the illustrated presentations include content relating to diabetes, the types of available treatments, and methods for managing the patient's health. As can bee seen in FIG. 4, the amount of points that may be earned by viewing each presentation is also provided. The webpage also provide a summary of the user's current reward point total 404 as well as a wish list 406 that the patient has created identifying prizes that the patient is working towards.

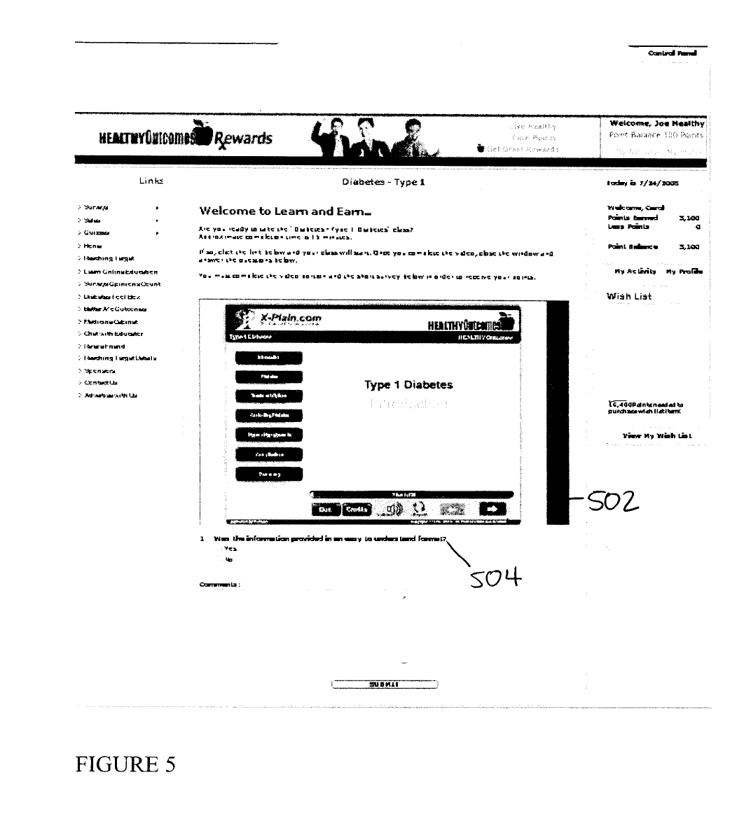

FIG. 5-7 illustrates several examples of educational presentations (502, 602, and 702) relating to diabetes that may be accessed by the patient. As shown in these figures, a questionnaire (504, 604, and 704) may also be provided to the patient to confirm that the patient has viewed the module. In these examples, only one question is provided for each presentation, but it is understood that any number of questions may be used. The questionnaire is preferably available to be answered by the patient after the education content is completed, but may also be provided at any time as a matter of design choice. Once the patient completes viewing of the presentation and answers the questionnaire, the patient's account is awarded the proper number of points, and the patient's points total is updated.

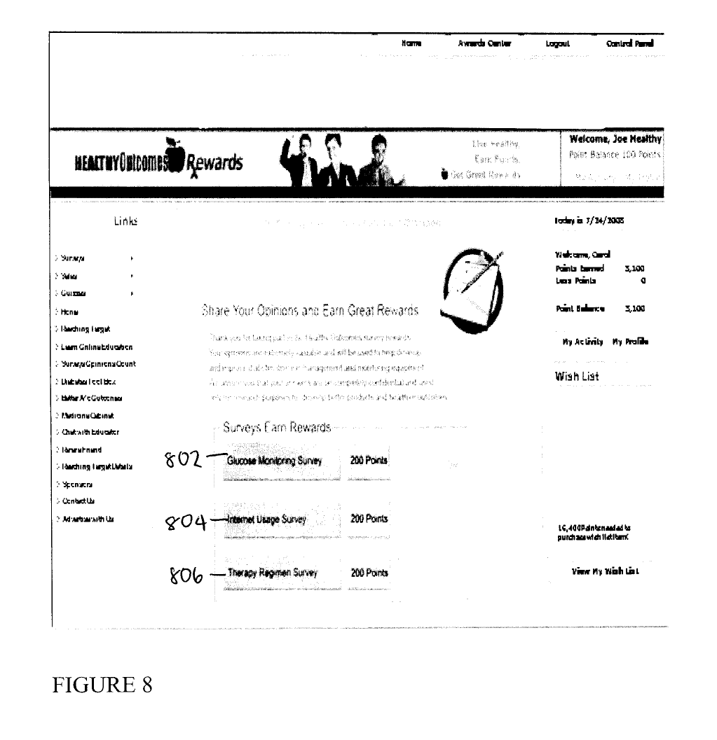

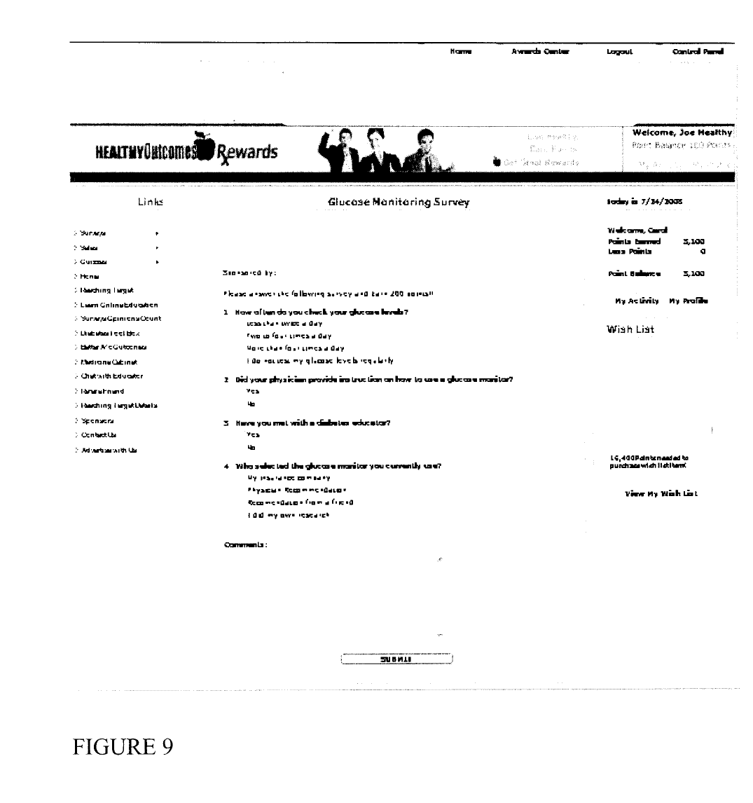

FIGS. 8-11 illustrate various aspects of one example of a survey module in accordance with the present invention. In FIG. 8, upon selecting the Survey module 304 in FIG. 3, the patient is presented with a number of available surveys. In this example, three surveys are shown as being available. These include a glucose monitoring survey 802, an internet usage survey 804, and a therapy regimen survey 806. Of course, it is understood that any number of surveys may be provided, and the surveys may involve various health-related issues. The number of points that may be earned by participating in each survey are also illustrated. FIGS. 9-11 illustrates exemplary embodiments of the surveys that may be accessed via the web page in FIG. 8. In this embodiment, the surveys are presented in a multiple-choice format, but it is understood that any question format may be used.

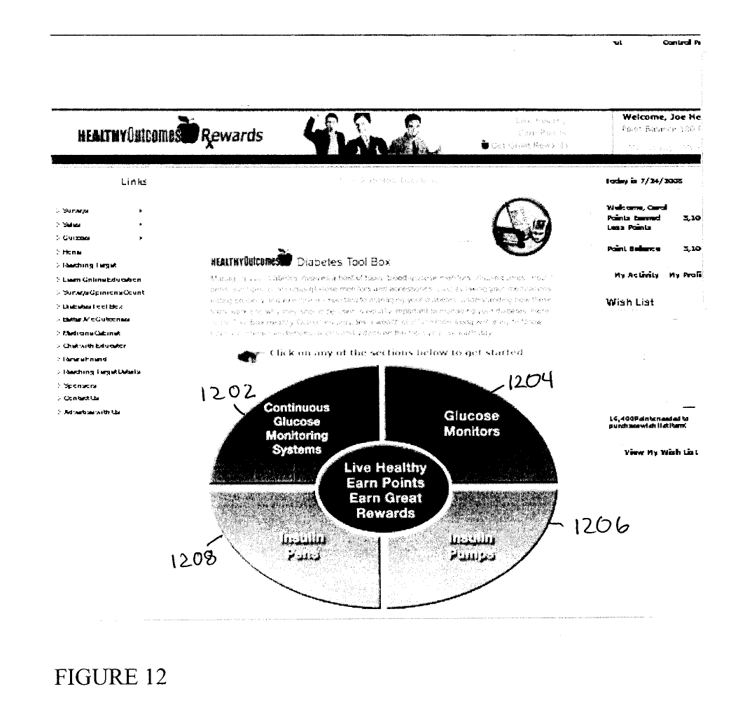

FIG. 12 illustrates one example of a tool box module 306 in which the patient may access product information relating to a particular disease or ailment, in this case diabetes. In this particular example, the patient is provided links to access informational content relating to glucose monitoring systems 1202, glucose monitors 1204, insulin pumps 1206, and insulin pens 1208. Of course, it should be understood that information may also be provided regarding other types of products.

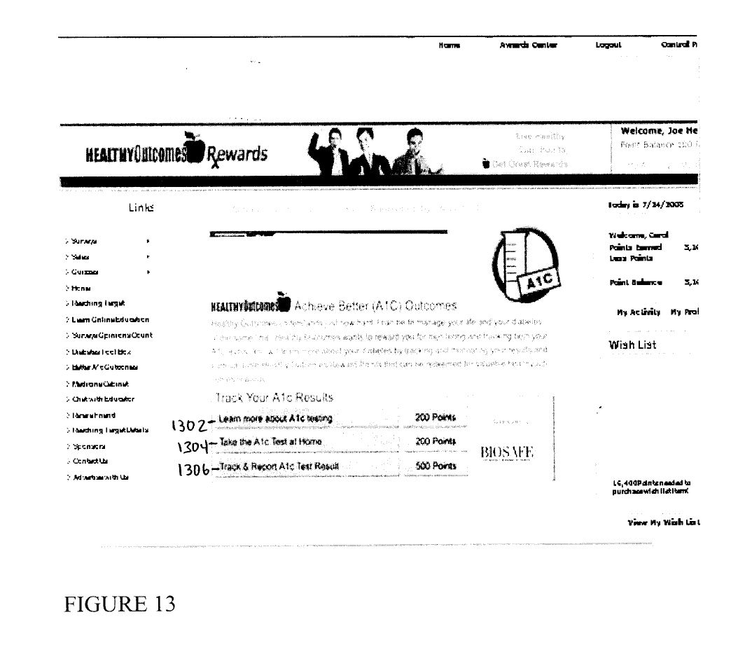

FIG. 13 illustrates one example of an achievement module 308 in accordance with the present invention. In this example, the patient is provided with selectable links relating to tracking and monitoring an A1c measurement, which is a blood glucose measurement for diabetes patients. As can bee seen, the patient can select to learn more about A1c testing 1302, which would permit the patient to view educational content about A1c testing. The patient can also select to view educational content about taking A1c measurements at home 1304. Finally, the patient can also select t report his or her A1c test results 1306. As can be seen, points are awarded to the patient for accessing each of these links.

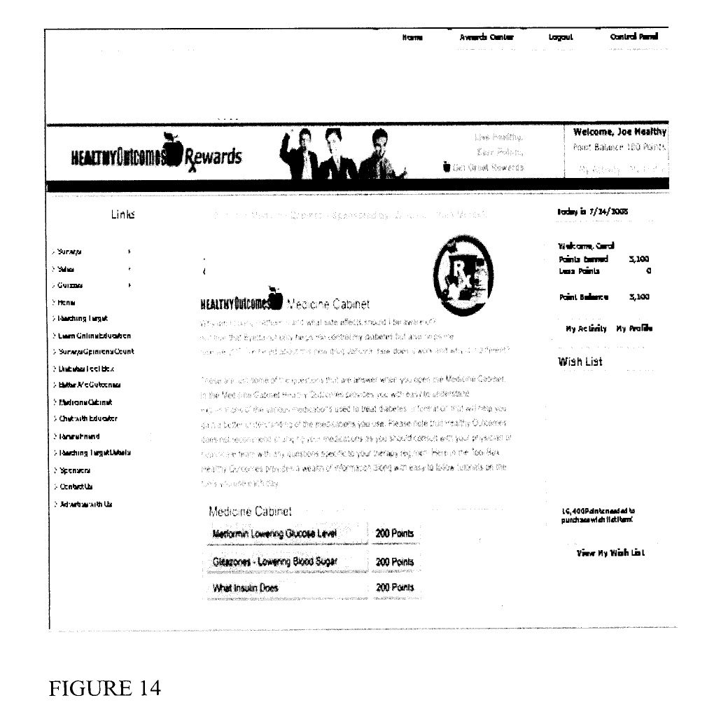

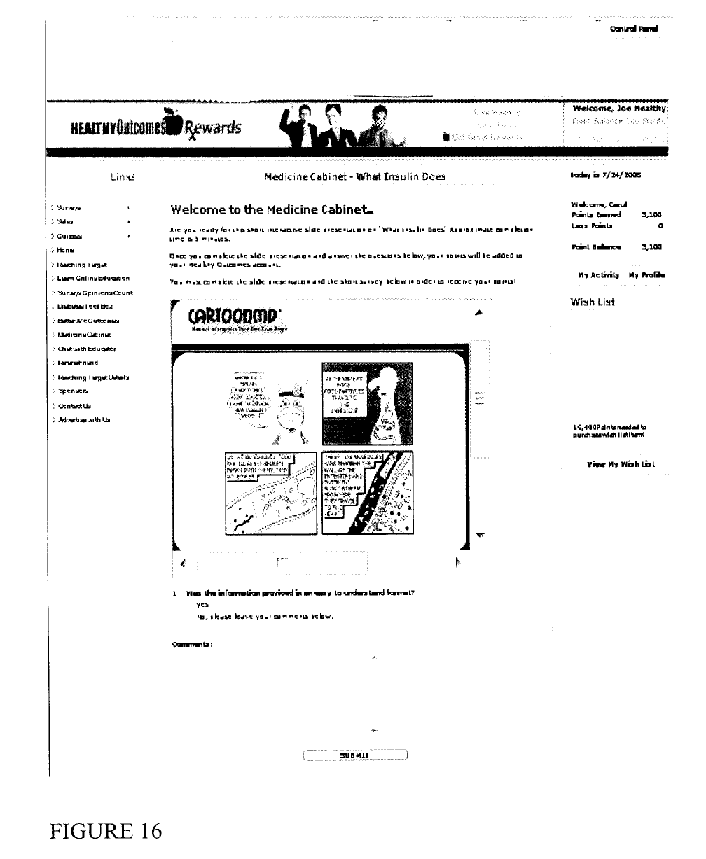

FIGS. 14-16 illustrate various elements of one example of a medicine cabinet module 310 in accordance with the present invention. As shown in FIG. 14, upon accessing the medicine cabinet module 310, the patient is presented with selectable links to educational content regarding one or more pharmaceutical products (in this example metformin and glitazones), or other educational content regarding information relevant to proper use of pharmaceutical products (e.g., education content about “what insulin does” in FIG. 16). Again, as can bee seen, point are awarded to the patient for accessing content via each of these links.

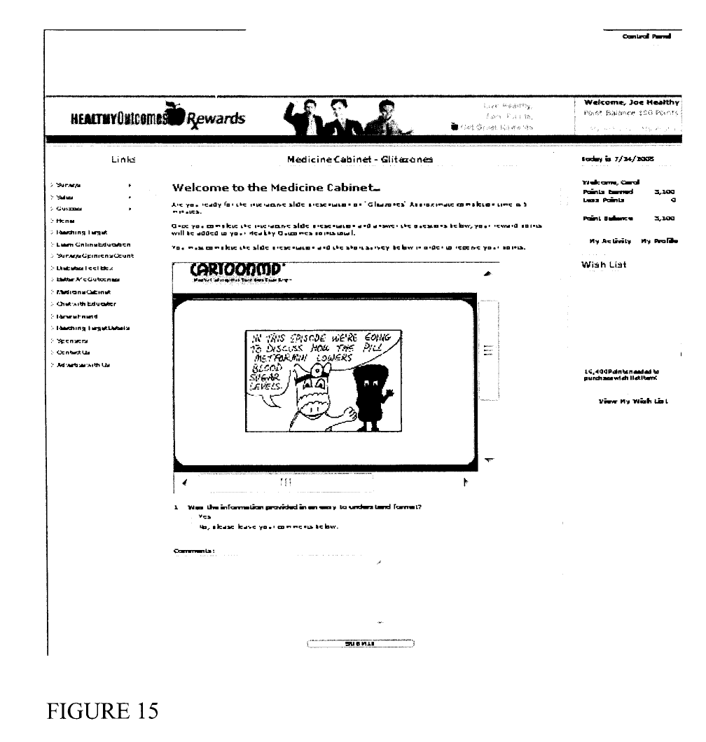

FIGS. 15 and 16 illustrate exemplary educational presentation that may be provided via the medicine cabinet module 310. In this example, the content is provided as a video cartoon, but as noted above, any format may be used. As shown in the figures, a questionnaire is also provided to make sure the patient has viewed the content so that points can be awarded to the patient.

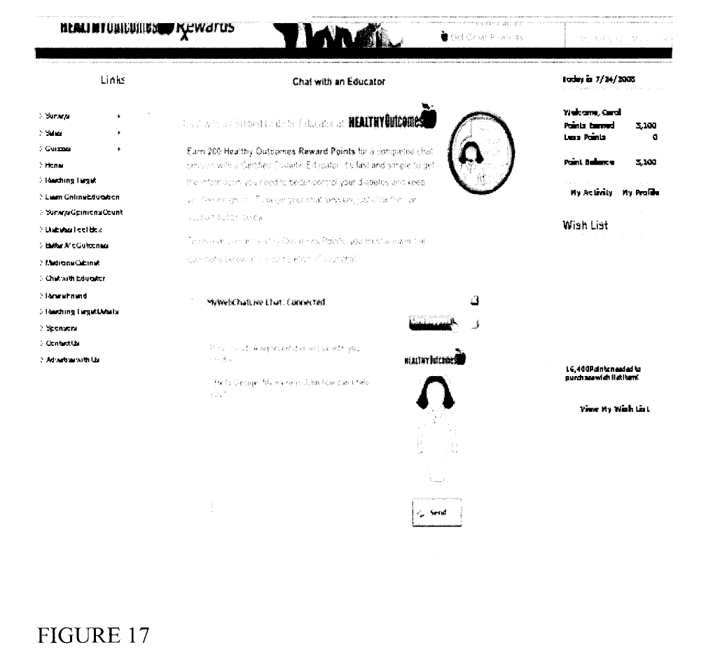

FIG. 17 provides one example of a chat module 312 in accordance with the present invention. In this module the patient may access a live chat with a health practitioner via the website. The health practitioner may then chat with the patient regarding their disease or condition, and provide information to the patient. Patients may also be provided the option to chat with other patients.

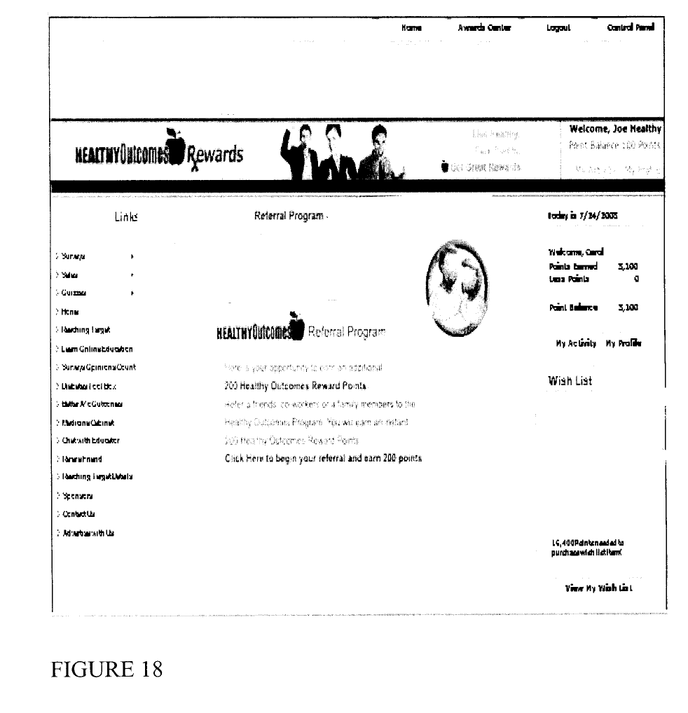

FIG. 18 illustrates one example of a referral module 314 in accordance with the present invention. On this we page, a patient can refer another to the website, and obtain points when that person registers for the program.

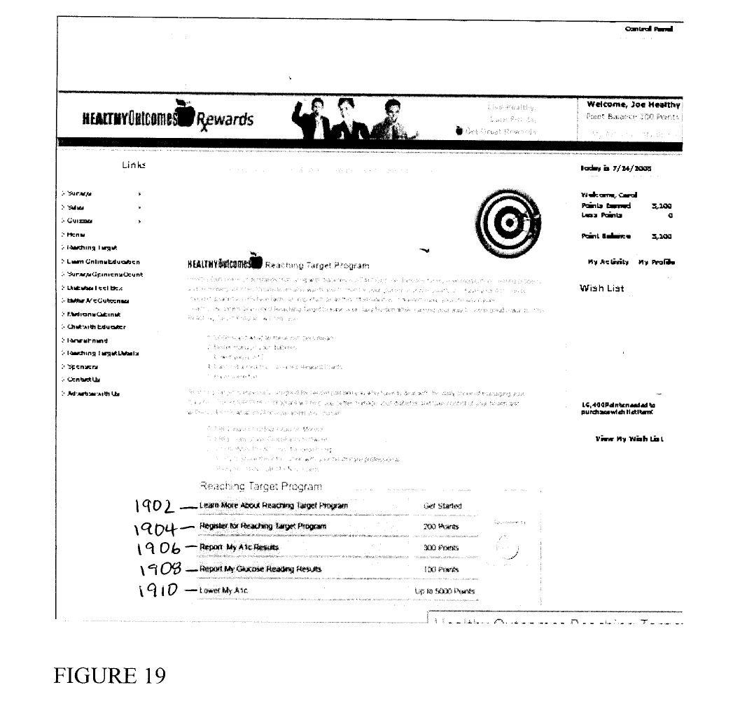

Finally, FIG. 19 illustrates one example of the Reaching Target module 316. As shown in FIG. 19, upon accessing this module, the patient is presented with links to various activities. In this example, these include educational content about using this module 1902, registering to the reaching target program 1904, reporting the results of A1c testing 1906 and glucose monitoring results 1908, and educational content on improve the patient's blood profile 1910. As shown, various amounts of points are awarded to the patient after completion of the activities.

Although the embodiment illustrated by the figures relates to diabetes, the present invention may be applied to many chronic diseases and conditions including, but not limited to, the different types of diabetes, heart disease, pulmonary disease (including asthma), and cancer. The present invention may also include modules relating to general nutrition.

Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure cover all such modifications and variations provided they come within the scope of the following claims and their equivalents.

What is claimed is:

1. A method for providing health care information and educational content to patients comprising:
providing a user-accessible website, the user-accessible website having at least one user-accessible module, the at least one user-accessible module being configured to provide a user the ability to access health-related educational content;
determining the specific education content accessed and viewed by a user;
awarding rewards incentives to the user based on the educational content accessed and viewed by the user;
tracking the total amount of rewards incentives awarded to the user; and
providing a selection of prizes that may be exchanged for a predetermined amount of rewards incentives.

2. The method of claim 1 wherein the at least one user-accessible module includes a health education module having educational content relating to one or more diseases.

3. The method of claim 2 wherein the at least one user-accessible module includes a medical product education module having educational content relating to one or more medical products.

4. The method of claim 3 wherein the at least one user-accessible module includes a pharmaceutical education module having education content relating to one or more pharmaceutical products.

5. The method of claim 3 wherein determining the education content accessed and viewed by a user includes:
providing a questionnaire to the user, the questionnaire being associated with the education content; and
determining whether the user has answered the questionnaire.

6. The method of claim 1 wherein the at least one user-accessible module further includes a survey module configured to provide the user the ability to access at least one survey, the method further including:
determining the specific surveys completed by the user; and
awarding rewards incentives to the user based on the completed surveys.

7. The method of claim 1 wherein the at least one user-accessible module further includes a health monitoring module configured to provide the user the ability to input health information; the method further including:
determining whether the user has input health information; and
awarding rewards incentives to the user if the user has input health information.

8. The method of claim 7 wherein the health information includes medical test results.

9. The method of claim 7 wherein the health information is transmitted to the user's health provider.

10. The method of claim 1 wherein the at least one user-accessible module further includes a target outcome module; the method further including:
setting a health-based target for the user;
determining whether the user has input health reached the target; and
awarding rewards incentives to the user based if the user has reached the target.
